(19) United States
(12) Patent Application Publication
(10) Pub. No.: US 2017/0176747 A1
(43) Pub. Date: Jun. 22, 2017

(54) Multi-Pupil Display System for Head-Mounted Display Device

(71) Applicants: Tuomas Heikki Sakari Vallius, Espoo (FI); Richard Andrew Wall, Kirkland, WA (US); Pasi Petteri Pietilä, Espoo (FI); Yarn Chee Poon, Redmond, WA (US); Ian Anh Nguyen, Renton, WA (US); Jeb Wu, Redmond, WA (US)

(72) Inventors: Tuomas Heikki Sakari Vallius, Espoo (FI); Richard Andrew Wall, Kirkland, WA (US); Pasi Petteri Pietilä, Espoo (FI); Yarn Chee Poon, Redmond, WA (US); Ian Anh Nguyen, Renton, WA (US); Jeb Wu, Redmond, WA (US)

(21) Appl. No.: 14/977,603

(22) Filed: Dec. 21, 2015

(51) Int. Cl. G02B 27/01; G02B 6/35; G02B 27/10

(52) U.S. Cl. CPC G02B 27/0172; G02B 27/1066; G02B 6/3598; G02B 2027/0134

(57) ABSTRACT

Disclosed are an apparatus and method for increasing the FOV of displayed images in a head-mounted display (HMD) device. A display apparatus comprises a display module and a waveguide optically coupled to the display module. The display module may generate individually multiple different portions of an image, to be conveyed to an optical receptor of a user of the HMD device, and may include multiple optical output ports, each to output a different portion of the image. The waveguide may include multiple optical input ports, each optically coupled to a different one of the optical output ports of the display module, where the waveguide is configured to output, to the optical receptor of the user, light corresponding to the image in its entirety.

### BACKGROUND

Head-mounted display (HMD) devices have been introduced into the consumer marketplace recently to support visualization technologies such as augmented reality (AR) and virtual reality (VR). An HMD device may include components such as one or more light sources, microdisplay modules, controlling electronics, and various optics such as waveguides, lenses, beam splitters, etc.

An important design parameter in at least some HMD devices is the field-of-view (FOV) of the device, particularly though not exclusively in HMD devices designed for AR applications. A larger FOV generally tends to provide a higher quality visualization experience for the user, while a FOV that is too small can undermine that experience. However, in certain HMD device designs, particularly those that use one or more waveguides to project light to the user, it may be difficult to achieve a sufficiently large FOV, because the FOV is limited by the refractive index of the material from which the waveguide is constructed.

### SUMMARY

Introduced here are at least one apparatus and at least one method (collectively and individually, “the technique introduced here”) for increasing the FOV of displayed images in a display device, particularly (though not necessarily) a body-mounted display device such as an HMD device. The following description generally assumes that the “user” of the display device is a human, to facilitate description. Note, however, that a display device embodying the technique introduced here can potentially be used by a user that is not human, such as a machine or an animal. Hence, the term “user” herein can refer to any of those possibilities, except as may be otherwise stated or evident from the context. Further, the term “optical receptor” is used herein as a general term to refer to a human eye, an animal eye, or a machine-implemented optical sensor designed to detect an image in a manner analogous to a human eye.

The technique introduced here includes a display apparatus that comprises a display module and a waveguide that is optically coupled to the display module. In certain embodiments, the display module generates individually multiple different portions of an image, to be conveyed to an optical receptor of a user of the display device, and the display module includes multiple optical output ports, each to output a different portion of the image. The waveguide includes multiple optical input ports, each optically coupled to a different one of the optical output ports of the display module, where the waveguide is configured to output, to the optical receptor of the user, light corresponding to the image in its entirety.

In some embodiments, the display module comprises a light source, a microdisplay imager, an optical switch element, and a pupil relay. The pupil relay may be optically coupled to receive light from the optical switch element and to relay light from the optical switch element to a first optical input port of the plurality of optical input ports of the waveguide. The optical switch element may be configured to cause light to be transmitted selectively along a first optical path to the first optical input port via the pupil relay or along a second optical path to a second optical input port of the plurality of optical input ports, according to a selection criterion. The selection criterion may be, for example, polarization of the light input to the optical switch element or a temporal criterion.

In some embodiments, the display module comprises multiple microdisplay imagers for each optical receptor of the user, where each of the microdisplay imagers generate a separate portion of an image being optically coupled to receive light from the light source. In such embodiments, the display device may include an optical transmission assembly to convey light from a first microdisplay imager to a first optical input port of the waveguide and to convey light from the second microdisplay imager to a second optical input port of the waveguide.

Other aspects of the technique will be apparent from the accompanying figures and detailed description.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

One or more embodiments of the present disclosure are illustrated by way of example and not limitation in the figures of the accompanying drawings, in which like references indicate similar elements.

FIG. 1 shows an example of an HMD device that may incorporate the technique introduced herein.

FIG. 2A shows a right side view of display components that may be contained within the HMD device of FIG. 1.

FIG. 2B shows a front view of display components that may be contained within the HMD device of FIG. 1.

FIG. 3 shows a single input pupil waveguide to convey light to a particular eye of the user.

FIG. 4 shows a multiple input pupil waveguide to convey light to a particular eye of the user.

FIG. 5 schematically shows an example of relevant components of the display module for one eye of the user, usable in connection with the multiple input pupil waveguide in FIG. 4.

FIG. 6 schematically shows an example of relevant components of the display module for one eye of the user, usable in connection with the multiple input pupil waveguide in FIG. 4, for an embodiment that uses a light engine containing multiple imagers.

FIG. 7 schematically illustrates an example of relevant components of the light engine of FIG. 6.

FIG. 8 illustrates an example of a method of using multiple input pupils on a waveguide in an HMD device.

### DETAILED DESCRIPTION

In this description, references to “an embodiment”, “one embodiment” or the like, mean that the particular feature, function, structure or characteristic being described is included in at least one embodiment of the technique introduced here. Occurrences of such phrases in this specification do not necessarily all refer to the same embodiment. On the other hand, the embodiments referred to also are not necessarily mutually exclusive.

Some AR-enabled HMD devices include one or more transparent waveguides arranged so that they are positioned to be located directly in front of each eye of the user when the HMD device is worn by the user, to project light representing generated images into the eye of the user. With such a configuration, images generated by the HMD device can be overlaid on the user's view of the real world. The FOV of such an HMD display device may be limited, however, by the refractive index of the materials used to make the waveguides. This constraint can be mitigated by providing two or more input pupils/in-coupling elements on the waveguide for each eye of the user, which enables a significantly larger FOV to be achieved with currently available materials and manufacturing technology.

One way to accommodate the use of two or more in-coupling elements/pupils on a waveguide (per eye) would be to use two or more corresponding light engines for each eye. A light engine is a component assembly that includes one or more light sources (e.g., red, green and blue light sources), one or more microdisplay imagers, and associated optics. However, the use of multiple light engines for each eye increases weight, price and size significantly, which is undesirable in a small-footprint device such as an HMD device. Additionally, the mechanical alignment between multiple light engines is challenging, since the tolerances tend to be on the order of arc-seconds in order to provide adequate image quality. Therefore, the use of two light engines on a waveguide may not be desirable with existing technology.

The technique introduced here, however, overcomes this challenge by providing a switchable element in a light engine, to switch the direction of the image to at least two different optical paths, and relay optics to transfer the pupil to another location. The relay optics can be placed after the switching element to transfer the image further away from the light engine, to enable larger distances between the in-coupling elements. This technique, therefore, enables a single light engine to provide two pupils for the image to two separate input ports on a waveguide, without significantly increasing the cost and size of the system, thereby greatly increasing the FOV with current materials and manufacturing technologies.

Another approach to solving this problem is to combine two or more microdisplay imagers in the same light engine. The same illumination and imaging optics can be used to produce two overlaying images, which can be separated using, for example, a polarization mirror. As with the approach mentioned above, relay optics can be used to transfer any one or more of the pupils further away from the light engine, to enable the input ports on the waveguide to be located relatively far away from each other. Additional details regarding the technique introduced here are provided below.

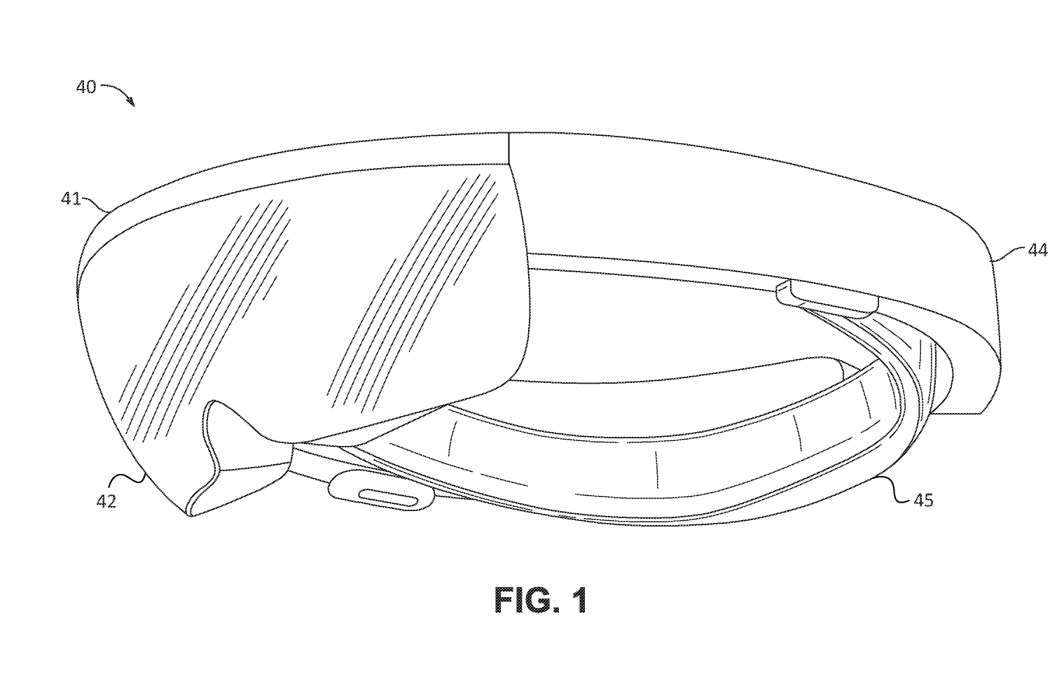

FIG. 1 shows an example of an HMD device in which the technique introduced here can be incorporated. The HMD device 40 may provide virtual reality (VR) and/or augmented reality (AR) display modes for the user, i.e., the wearer of the device. To facilitate description, it is henceforth assumed that the HMD device 40 is designed for AR visualization.

In the illustrated embodiment, the HMD device 40 includes a chassis 41, a transparent protective visor 42 mounted to the chassis 41, and left and right side arms 44 mounted to the chassis 41. The visor 42 forms a protective enclosure for various display elements (not shown) that are discussed below.

The chassis 41 is the mounting structure for the visor 42 and side arms 44, as well as for various sensors and other components (not shown) that are not germane to this description. A display assembly (not shown) that can generate images for AR visualization is also mounted to the chassis 41 and enclosed within the protective visor 42. The visor assembly 42 and/or chassis 41 may also house electronics (not shown) to control the functionality of the display assembly and other functions of the HMD device 40. The HMD device 40 further includes an adjustable headband 45 attached to the chassis 41, by which the HMD device 40 can be worn on a user's head.

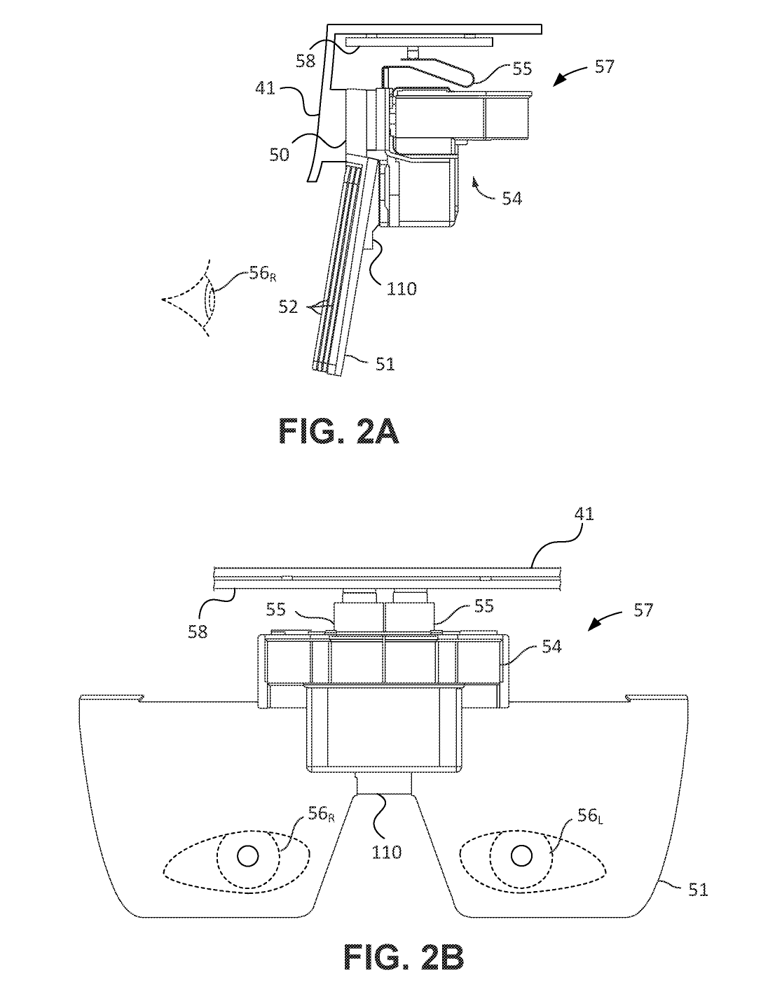

FIGS. 2A and 2B show, in accordance with certain embodiments, right side and front orthogonal views, respectively, of display components that may be contained within the visor 42 of the HMD device 40. During operation of the HMD device 40, the display components are positioned relative to the user's left eye 56_{L} and right eye 56_{R} as shown. The display components are mounted to the interior surface of the chassis 41. The chassis 41 is shown in cross-section in FIG. 2A.

The display components are designed to overlay three-dimensional images on the user's view of his real-world environment, e.g., by projecting light into the user's eyes. Accordingly, the display components include a display module 54 that houses a light engine including components such as: one or more light sources (e.g., one or more light emitting diodes (LEDs)); one or more microdisplay imagers, such as liquid crystal on silicon (LCOS), liquid crystal display (LCD), digital micromirror device (DMD); and one or more lenses, beam splitters and/or waveguides. The microdisplay imager(s) (not shown) within the display module 54 may be connected via a flexible circuit connector 55 to a printed circuit board 58 that has image generation/control electronics (not shown) mounted on it.

The display components further include a transparent waveguide carrier 51 to which the display module 54 is mounted, and multiple transparent waveguides 52 stacked on the user's side of the waveguide carrier 51, for each of the left eye and right eye of the user. The waveguide carrier 51 has a central nose bridge portion 110, from which its left and right waveguide mounting surfaces extend. Multiple waveguides 52 are stacked on each of the left and right waveguide mounting surfaces of the waveguide carrier 51, to project light emitted from the display module and representing images into the left eye 56_{L} and right eye 56_{R}, respectively, of the user. The display assembly 57 can be mounted to the chassis 41 through a center tab 50 located at the top of the waveguide carrier 51 over the central nose bridge section 110.

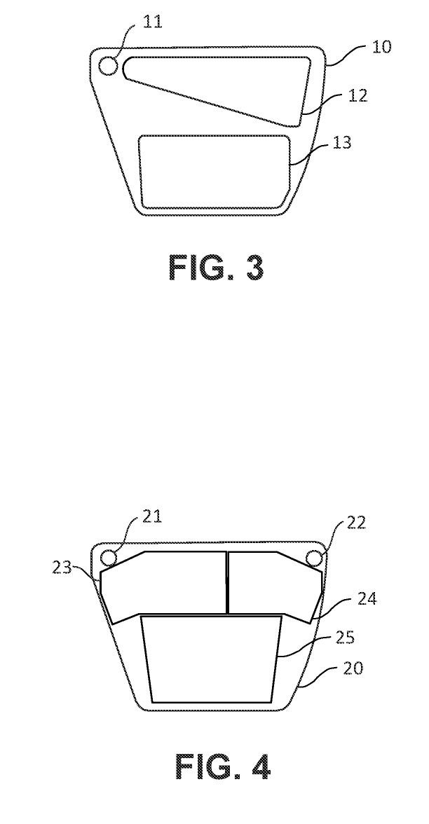

FIG. 3 shows a single input pupil design for a waveguide that can be mounted on the waveguide carrier 51 to convey light to a particular eye of the user, in this example, the right eye of user. A similar waveguide can be designed for the left eye, for example, as a (horizontal) mirror image of the waveguide shown in FIG. 3. The waveguide 10 is transparent and, as can be seen from FIGS. 2A and 2B, would normally be disposed directly in front of the right eye of the user during operation of the HMD device, e.g., as one of the waveguides 52 in FIG. 2A. The waveguide 10 is, therefore, shown from the user's perspective during operation of the HMD device 40.

The waveguide 10 includes a single input port 11 (also called in-coupling element, and corresponding to the single input pupil) located in the region of the waveguide 10 that is closest to the user's nose bridge when the HMD device 40 is worn by the user. The input port 11 may be formed from, for example, a surface diffraction grating, volume diffraction grating, or a reflective component. The waveguide 10 further includes a single output port 13 (also called out-coupling element) and a transmission channel 12. A right-eye output port of the display module (not shown) is optically coupled (but not necessarily physically coupled) to the input port 11 of the waveguide 10. During operation, the display module 54 (not shown) outputs light representing an image for the right eye from its right-eye output port into the input port 11 of the waveguide 10.

The transmission channel 12 conveys light from the input port 11 to the output port 13 and may be, for example, a surface diffraction grating, volume diffraction grating, or a reflective component. The transmission channel 12 may be designed to accomplish this by use of total internal reflection (TIR). Light representing the image for the right eye is then projected from the output port 13 to the user's eye.

As mentioned above, however, the single input port design shown in FIG. 3 has a relatively limited FOV. FIG. 4, therefore, shows a dual-input pupil design for a waveguide, which can be used instead of the waveguide in FIG. 3 to provide a greater FOV. Note that while the present disclosure describes waveguides with one or two input ports/pupils and a single output port/pupil, a display device incorporating the technique introduced here may have a waveguide with more than two input ports/pupils and/or more than one output port/pupil for a given eye. Further, while the example of FIG. 4 is for the right eye, a similar waveguide can be designed for the left eye, for example, as a (horizontal) mirror image of the waveguide in FIG. 4.

As shown, the waveguide 20 in FIG. 4 includes two separate input ports 21 and 22, two transmission channels 23 and 24, and an output port 25. During operation, each of the input ports 21, 22 receives light (from the display module 54) representing a different portion of the image for the right eye of the user. Each of the transmission channels 23, 24 is optically coupled to a separate one of the input ports 21 or 22 and conveys light from only the corresponding input port 21 or 22 to the output port 25. Each of the transmission channels 23, 24 may be, for example, an internal or surface diffraction grating design to channel light by TIR. Light from the two different portions of the image is combined at the output port 25 and projected into the eye of the user as a single integrated image.

In some embodiments, the left input port 21 receives the left portion (e.g., half) of the image for one eye of the user (e.g., the right eye) while the right input port 22 receives the right portion (e.g., half) of the image for that same eye. Each portion of the image can include all of the color components that are present in the complete image, e.g., red, green and blue color components. The portions of the image may be generated in a tiled manner, i.e., where they are spatially contiguous and non-overlapping, or they may at least partially overlap spatially. Further, in other embodiments, rather than generating left and right portions of the image, the separate portions of the image could be upper and lower portions of the image, or the image could be spatially divided in some other manner. Additionally, the waveguide 20 could have more than two input ports, in which case the image could be provided to the waveguide 20 in the form of three or more separate image portions, which are reintegrated in the waveguide 20.

Hence, in at least some embodiments, different portions of an image for a given eye of the user are generated and input simultaneously into separate input ports of a waveguide, then reintegrated within the waveguide and projected into the eye of the user as a single integrated image, to produce a larger FOV. In other embodiments, the separate portions of the image could be input to the waveguide in a time division multiplexed manner, rather than simultaneously. Further, in some embodiments, the physical placement of the input ports on the waveguide may be different from that shown in FIG. 4. For example, the input ports could be spaced apart vertically on the waveguide rather than, or in addition to, horizontally. Other input port configurations are also possible.

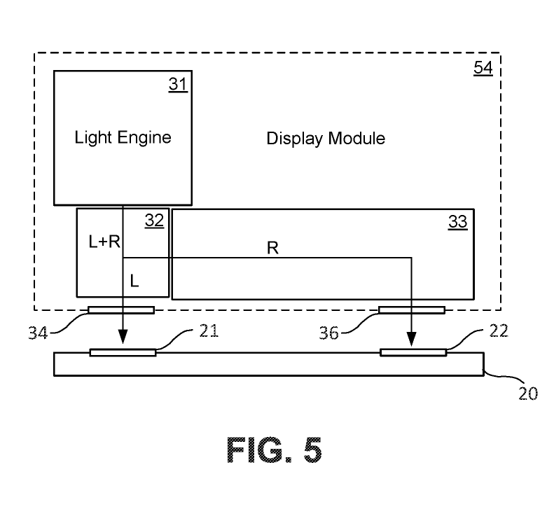

As mentioned above, one possible way to employ a dual input pupil waveguide, such as shown in FIG. 4, would be to use multiple light engines, i.e., one light engine for each input pupil. However, that approach has disadvantages, as discussed above. FIG. 5 illustrates an alternative approach that does not have the disadvantages of multiple light engines. In particular, FIG. 5 schematically shows an example of certain relevant components of the display module 54 for one eye of the user (left or right), that may be used in connection with a dual input pupil waveguide such as shown in FIG. 4. The view in FIG. 5 is from directly above the display module 54, looking down.

In the example of FIG. 5, the display module 54 includes a light engine 31, an optical switch 32 and a pupil relay 33. Though not shown, the display module 54 may also include similar or identical components for the other eye of the user. In some embodiments, the light engine 31 includes one or more light sources (not shown), such as one or more colored LEDs. For example, the light engine 31 can include red, green and blue LEDs to produce the red, green and blue color components, respectively, of the image. Additionally, the light engine 31 includes at least one microdisplay imager (not shown), such as an LCOS imager, LCD or DMD; and may further include one or more lenses, beam splitters, waveguides, and/or other optical components (not shown).

The optical switch 32 controls the propagation direction of the light output by the light engine 31, representing each particular portion of the image, to one of two different optical paths. In the illustrated embodiment, the first path is for the left half of the image and leads to an output port 34 of the display module 54 that is coupled to one corresponding input port 21 of the waveguide 20. The other optical path is for the right portion of the image and includes a pupil relay 33, which propagates that portion of the image to a second output port 36 of the display module 54, which is optically coupled to a second corresponding input port 22 of the waveguide 20.

The optical switch 32 selectively controls the propagation direction of light from the light engine 31 based on a switching criterion, such as polarization. For example, one half of the image may have s-polarization while the other half of image has p-polarization, where the optical switch 32 conveys s-polarized light along one optical path and conveys p-polarized light along the other optical path. The switch 32 can be, for example, an LCD mirror that either transmits light or acts as a perfect mirror, depending on the applied voltage. Note, however, that a switching criterion (or criteria) other than polarization could be used. For example, time division multiplexing could be used to switch between the optical paths.

The pupil relay 33 is optional but enables larger distances between the input ports 21, 22 on the waveguide 20. The pupil relay 33 may be constructed using any known or convenient method and materials for transferring an image pupil from one location to another. For example, the pupil relay 33 may be constructed from a sequence of paraxial lenses that focus the pupil to an intermediate image and then collimate it, followed by a mirror to redirect the light into the corresponding input port of the waveguide. The approach shown in FIG. 5, therefore, enables a single light engine to provide two pupils for an image to two separate in-coupling elements on a waveguide, without significantly increasing the cost and size of the system, thereby greatly increasing the FOV with current materials and manufacturing technologies.

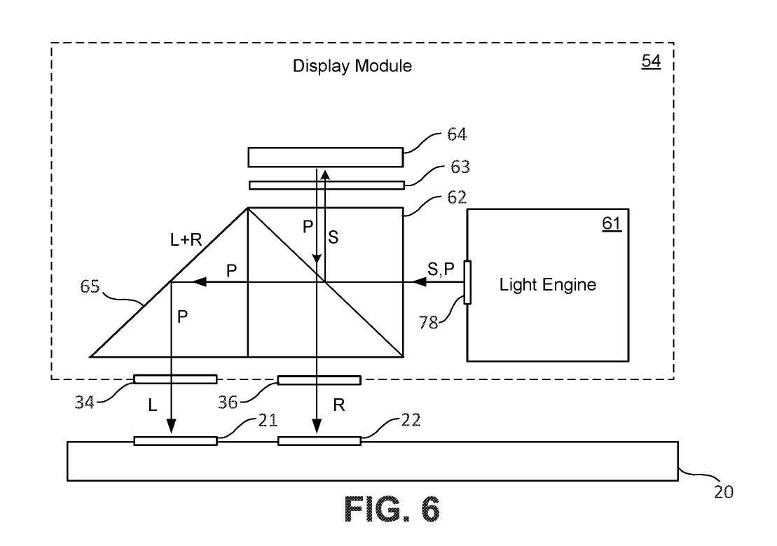

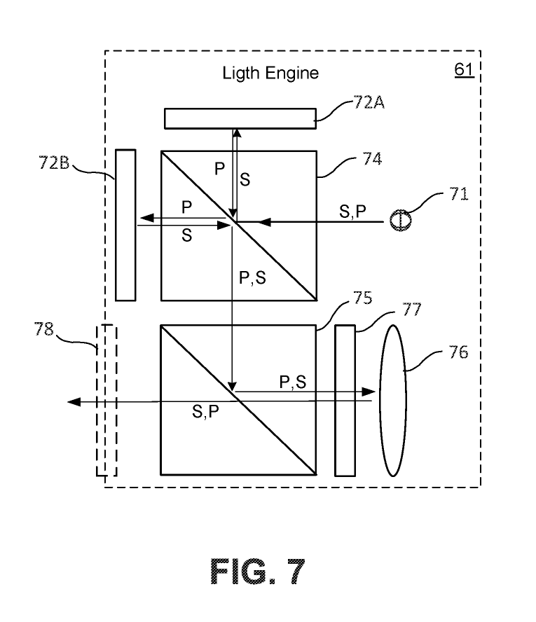

FIGS. 6 and 7 illustrate another embodiment that uses multiple input pupils on a waveguide, in which two (or more) microdisplay imagers are combined in the same light engine. Specifically, FIG. 6 schematically shows an example of certain relevant components of the display module 54 for such an embodiment. The view in FIG. 6 is from directly above the display module 54, looking down.

As shown, the same illumination and imaging optics can be used to produce two overlaying portions of an image, which can be separated using, for example, a polarizing beam splitter (PBS). The left and right portions of the image are initially separated within the light engine 61 into p-polarized and s-polarized light, respectively. Then, additional optics route these two portions of the image to the appropriate output port 34 or 36 of the display module 54, which are optically coupled to corresponding input ports 21 and 22, respectively, of the waveguide 20. Specifically, a PBS 62 in combination with a quarter-wave plate (retarder) 63 and polarization mirror 64 cause the initially s-polarized right portion of the image to be converted to p-polarized light that is directed to the right output port 36 of the display module 54, and from there, into the right input port 22 of the waveguide 20. Also, the PBS 62 in combination with prism 65 causes the initially p-polarized left portion of the image to be directed to the left output port 34 of the display module 54, and from there, into the left input port 21 of the waveguide 20. As with the approach described above, relay optics optionally can be used to transfer any one or more of the pupils further away from the light engine 61, to enable the input ports 21, 22 on the waveguide 20 to be located relatively far away from each other (e.g., as shown in FIGS. 4 and 5.

FIG. 7 schematically illustrates an example of certain relevant components of the light engine 61 of FIG. 6, according to certain embodiments. The view in FIG. 7 is from the right side of the display module 54. Note that some embodiments may include other active and/or passive components, not shown. The light engine 61 in the illustrated embodiment includes at least one light source 71, such as a color LED. Although only one light source 71 is shown in FIG. 7, in practice there may be multiple light sources provided for each eye of the user, e.g., one for each color component of whatever color model is being employed (e.g., red, green and blue). The same or a similar configuration as shown in FIG. 7 can be used to combine light from such multiple light sources.

The light engine 61 further includes multiple imagers (e.g., LCOS microdisplays) 72A and 72B that generate separate portions of an image intended for display to a particular eye of the user. The two imagers 72A, 72B can be identical in size, functionality, etc. A retarder (e.g., quarter-wave plate) can be placed before the waveguide at one of the waveguide inputs to have optimum polarization entering the waveguide.

Additionally, the light engine 61 includes a combination of PBSs 74, 75, one or more reflective lenses 76 and one or more quarter-wave plates 77, that generates the separate portions of the image and propagates them simultaneously through the output port 78 of the light engine 61. More specifically, a first PBS 74 reflects s-polarized light from the light source 71 upward to a first microdisplay imager 72A, which generates one portion of the image. The PBS 74 also causes p-polarized light from the light source 71 to be propagated straight through to the other microdisplay imager 72B, which produces a second portion of the image. Both portions of the image (separately constituting s-polarized and p-polarized light) then propagate downward through the PBS 74 to a second PBS 75, which directs them to birdbath-shaped reflective lenses 76 via quarter-wave plates (retarders) 77. The image portions are then reflected back by the reflective lenses 76 through the quarter-wave plates 77 and then through the PBS 75. From there, the image portions are output through the output port 78 of the light engine 61 and provided to additional optics in the display module 54, as shown by the example in FIG. 6.

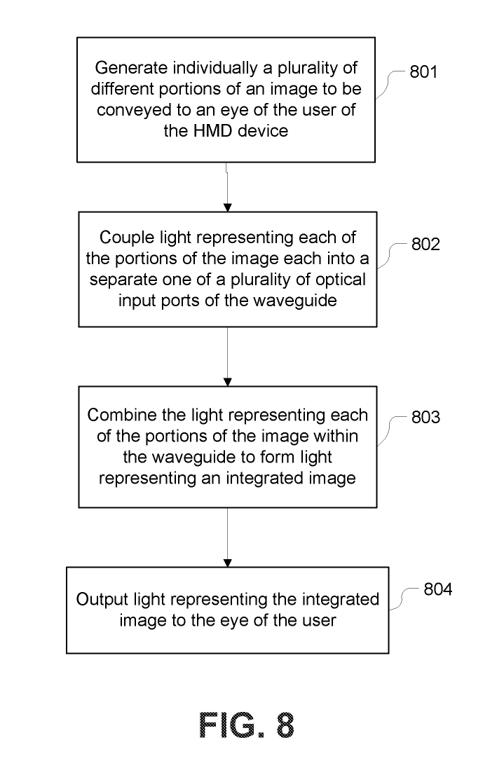

FIG. 8 illustrates an example of a method of using multiple input pupils on a waveguide in an HMD device. The method begins at step 801 with generating individually a plurality of different portions of an image to be conveyed to an eye of the user of the HMD device. Next, light representing each portion of the image is coupled into a separate one of a plurality of optical input ports of the waveguide at step 802. At step 803, the light representing the multiple portions of the image is combined within the waveguide to form light representing an integrated image. Light representing the integrated image is then output from the waveguide to the eye of the user at step 804.

### EXAMPLES OF CERTAIN EMBODIMENTS

Certain embodiments of the technology introduced herein are summarized in the following numbered examples:

1. A display apparatus comprising: a display module to generate individually a plurality of different portions of an image to be conveyed to an optical receptor of a user of a display device, the display module including a plurality of optical output ports, each to output a different one of the plurality of portions of the image; and a waveguide optically coupled to the display module and including a plurality of optical input ports, each of the optical input ports optically coupled to a different one of the plurality of optical output ports of the display module, the waveguide being configured to output, to the optical receptor of the user, light corresponding to the image in its entirety.

2. The display apparatus of example 1, wherein each of the portions of the image is a different spatial region of the image.

3. The display apparatus of example 1 or 2, wherein the plurality of portions of the image are spatially contiguous.

4. The display apparatus of example 1 or 2, wherein the plurality of portions of the image spatially overlap.

5. The display apparatus of any of examples 1 through 4, wherein the waveguide is configured to combine light representing the plurality of different portions of an image into a single integrated image and to output the single integrated image to the optical receptor of the user.

6. The display apparatus of any of examples 1 through 5, wherein the display module comprises: a light source; a microdisplay imager optically coupled to receive light from the light source; an optical switch element optically coupled to receive light from the microdisplay imager; and a pupil relay optically coupled to receive light from the optical switch element and to relay light from the optical switch element to a first optical input port of the plurality of optical input ports of the waveguide; wherein the optical switch element is configured to cause light to be transmitted selectively along a first optical path to the first optical input port via the pupil relay or along a second optical path to a second optical input port of the plurality of optical input ports, according to a selection criterion.

7. The display apparatus of any of examples 1 through 6, wherein the selection criterion comprises a polarization of the light input to the optical switch element.

8. The display apparatus of any of examples 1 through 7, wherein the selection criterion comprises a temporal criterion.

9. The display apparatus of any of examples 1 through 8, wherein the display module comprises: a light source; a plurality of microdisplay imagers, including a first microdisplay imager and a second microdisplay imager, each optically coupled to receive light from the light source, the first and second imagers configured to generate separate ones of the plurality of portions of the image; and an optical transmission assembly to convey light from the first microdisplay imager to a first optical input port of the waveguide and to convey light from the second microdisplay imager to a second optical input port of the waveguide.

10. A method comprising: generating individually a plurality of different portions of an image to be conveyed to an optical receptor of a user of a head-mounted display device; coupling light representing each of the portions of the image each into a separate one of a plurality of optical input ports of a waveguide; combining the light representing each of the portions of the image within the waveguide to form light representing an integrated image; and outputting light representing the integrated image to the optical receptor of the user.

11. The method of example 10, wherein each of the portions of the image is a different spatial region of the image.

12. The method of example 10 or 11, wherein the plurality of portions of the image are spatially contiguous.

13. The method of example 10 or 11, wherein the plurality of portions of the image spatially overlap.

14. The method of any of examples 10 through 13, further comprising: causing light to be transmitted selectively onto a first optical path or onto a second optical path, according to a selection criterion; relaying light along the first optical path to a first optical input port of the plurality of optical input ports of the waveguide via a pupil relay; and coupling light along the second optical path directly to a second optical input port of the plurality of optical input ports of the waveguide.

15. The method of any of examples 10 through 14, wherein the selection criterion comprises a polarization of the light input to the optical switch element.

16. The method of any of examples 10 through 15, wherein the selection criterion comprises a temporal criterion.

17. The method of any of examples 10 through 17, wherein generating the plurality of different portions of the image comprises using a plurality of microdisplay imagers, including a first imager and a second imager, each to generate a separate one of the plurality of portions of the image, based on light emitted from a light source; the method further comprising: conveying light from the first imager through an optical transmission assembly to a first optical input port of the waveguide; and conveying light from the second imager through the optical transmission assembly to a second optical input port of the waveguide.

18. A display apparatus comprising: a waveguide configured to combine light representing each of a plurality of different portions of an image to form light representing an integrated image and to output light representing the integrated image for propagation to an optical receptor of a user of a head-mounted display device; and image generation means for generating individually the plurality of different portions of the image and for coupling light representing each of the portions of the image each into a separate one of a plurality of optical input ports of the waveguide.

19. The display apparatus of example 18, wherein the image generation means comprises: a switch to cause light to be transmitted selectively onto a first optical path or onto a second optical path, according to a selection criterion; a pupil relay to relay light along the first optical path to a first optical input port of the plurality of optical input ports of the waveguide; and an optical coupling to convey light along the second optical path directly to a second optical input port of the plurality of optical input ports of the waveguide.

20. The display apparatus of example 18 or 19, wherein the image generation means comprises a first imager and a second imager, and means for using the first imager and the second imager each to generate a separate one of the plurality of portions of the image, based on light emitted from a light source; the display apparatus further comprising an optical assembly to convey light from the first imager to a first optical input port of the waveguide; and to convey light from the second imager to a second optical input port of the waveguide.

21. An apparatus comprising: means for generating individually a plurality of different portions of an image to be conveyed to an optical receptor of a user of a head-mounted display device; means for coupling light representing each of the portions of the image each into a separate one of a plurality of optical input ports of a waveguide; means for combining the light representing each of the portions of the image within the waveguide to form light representing an integrated image; and means for outputting light representing the integrated image to the eye of the user.

22. The apparatus of example 21, wherein each of the portions of the image is a different spatial region of the image.

23. The apparatus of example 21 or 22, wherein the plurality of portions of the image are spatially contiguous.

24. The apparatus of example 21 or 22, wherein the plurality of portions of the image spatially overlap.

25. The apparatus of any of examples 21 through 24, further comprising: means for causing light to be transmitted selectively onto a first optical path or onto a second optical path, according to a selection criterion; means for relaying light along the first optical path to a first optical input port of the plurality of optical input ports of the waveguide via a pupil relay; and means for coupling light along the second optical path directly to a second optical input port of the plurality of optical input ports of the waveguide.

26. The apparatus of any of examples 21 through 25, wherein the selection criterion comprises a polarization of the light input to the optical switch element.

27. The apparatus of any of examples 21 through 26, wherein the selection criterion comprises a temporal criterion.

28. The apparatus of any of examples 21 through 27, wherein generating the plurality of different portions of the image comprises using a plurality of microdisplay imagers, including a first imager and a second imager, each to generate a separate one of the plurality of portions of the image, based on light emitted from a light source; the apparatus further comprising: means for conveying light from the first imager through an optical transmission assembly to a first optical input port of the waveguide; and means for conveying light from the second imager through the optical transmission assembly to a second optical input port of the waveguide.

Any or all of the features and functions described above can be combined with each other, except to the extent it may be otherwise stated above or to the extent that any such embodiments may be incompatible by virtue of their function or structure, as will be apparent to persons of ordinary skill in the art. Unless contrary to physical possibility, it is envisioned that (i) the methods/steps described herein may be performed in any sequence and/or in any combination, and that (ii) the components of respective embodiments may be combined in any manner.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

Attorney docket no.

041827

-

8101

.us

01

(patent) claims what is claimed is:

1. A display apparatus comprising:
a display module to generate individually a plurality of different portions of an image to be conveyed to an optical receptor of a user of a display device, the display module including a plurality of optical output ports, each to output a different one of the plurality of portions of the image; and
a waveguide optically coupled to the display module and including a plurality of optical input ports, each of the optical input ports optically coupled to a different one of the plurality of optical output ports of the display module, the waveguide being configured to output, to the optical receptor of the user, light corresponding to the image in its entirety.

2. The display apparatus of claim 1, wherein each of the portions of the image is a different spatial region of the image.

3. The display apparatus of claim 2, wherein the plurality of portions of the image are spatially contiguous.

4. The display apparatus of claim 2, wherein the plurality of portions of the image spatially overlap.

5. The display apparatus of claim 1, wherein the waveguide is configured to combine light representing the plurality of different portions of an image into a single integrated image and to output the single integrated image to the optical receptor of the user.

6. The display apparatus of claim 1, wherein the display module comprises:
a light source;
a microdisplay imager optically coupled to receive light from the light source;
an optical switch element optically coupled to receive light from the microdisplay imager; and
a pupil relay optically coupled to receive light from the optical switch element and to relay light from the optical switch element to a first optical input port of the plurality of optical input ports of the waveguide;
Attorney Docket No. 041827-8101.US01 (PATENT) wherein the optical switch element is configured to cause light to be transmitted selectively along a first optical path to the first optical input port via the pupil relay or along a second optical path to a second optical input port of the plurality of optical input ports, according to a selection criterion.

7. The display apparatus of claim 6, wherein the selection criterion comprises a polarization of the light input to the optical switch element.

8. The display apparatus of claim 6, wherein the selection criterion comprises a temporal criterion.

9. The display apparatus of claim 1, wherein the display module comprises:
a light source;
a plurality of microdisplay imagers, including a first microdisplay imager and a second microdisplay imager, each optically coupled to receive light from the light source, the first and second imagers configured to generate separate ones of the plurality of portions of the image; and
an optical transmission assembly to convey light from the first microdisplay imager to a first optical input port of the waveguide and to convey light from the second microdisplay imager to a second optical input port of the waveguide.

10. A method comprising:
generating individually a plurality of different portions of an image to be conveyed to an optical receptor of a user of a head-mounted display device;
coupling light representing each of the portions of the image each into a separate one of a plurality of optical input ports of a waveguide;
combining the light representing each of the portions of the image within the waveguide to form light representing an integrated image; and
outputting light representing the integrated image to the optical receptor of the user.

11. The method of claim 10, wherein each of the portions of the image is a different spatial region of the image. Attorney Docket No. 041827-8101.US01 (PATENT)

12. The method of claim 11, wherein the plurality of portions of the image are spatially contiguous.

13. The method of claim 11, wherein the plurality of portions of the image spatially overlap.

14. The method of claim 10, further comprising:
causing light to be transmitted selectively onto a first optical path or onto a second optical path, according to a selection criterion;
relaying light along the first optical path to a first optical input port of the plurality of optical input ports of the waveguide via a pupil relay; and
coupling light along the second optical path directly to a second optical input port of the plurality of optical input ports of the waveguide.

15. The method of claim 14, wherein the selection criterion comprises a polarization of the light input to the optical switch element.

16. The method of claim 14, wherein the selection criterion comprises a temporal criterion.

17. The method of claim 10, wherein generating the plurality of different portions of the image comprises using a plurality of microdisplay imagers, including a first imager and a second imager, each to generate a separate one of the plurality of portions of the image, based on light emitted from a light source;
the method further comprising:
conveying light from the first imager through an optical transmission assembly to a first optical input port of the waveguide; and
conveying light from the second imager through the optical transmission assembly to a second optical input port of the waveguide.

18. A display apparatus comprising:
a waveguide configured to combine light representing each of a plurality of different portions of an image to form light representing an integrated image and to output light Attorney Docket No. 041827-8101.US01 (PATENT) representing the integrated image for propagation to an optical receptor of a user of a head-mounted display device; and
image generation means for generating individually the plurality of different portions of the image and for coupling light representing each of the portions of the image each into a separate one of a plurality of optical input ports of the waveguide.

19. The display apparatus of claim 18, wherein the image generation means comprises:
a switch to cause light to be transmitted selectively onto a first optical path or onto a second optical path, according to a selection criterion;
a pupil relay to relay light along the first optical path to a first optical input port of the plurality of optical input ports of the waveguide; and
an optical coupling to convey light along the second optical path directly to a second optical input port of the plurality of optical input ports of the waveguide.

20. The display apparatus of claim 18, wherein the image generation means comprises a first imager and a second imager, and means for using the first imager and the second imager each to generate a separate one of the plurality of portions of the image, based on light emitted from a light source;
the display apparatus further comprising an optical assembly to convey light from the first imager to a first optical input port of the waveguide; and to convey light from the second imager to a second optical input port of the waveguide.
